(19) United States
(12) Patent Application Publication
(10) Pub. No.: US 2011/0062230 A1
(43) Pub. Date: Mar. 17, 2011

(54) Using A Mobile Device For Vending Payment

(75) Inventors: Seth WARD, II, Little Rock, AR (US); R. Todd BROWN, Russellville, AR (US); Johnny Jason HORTON, Russellville, AR (US)

(73) Assignee: POM INCORPORATED, Russellville, AR (US)

(21) Appl. No.: 12/558,202

(22) Filed: Sep. 11, 2009

(51) Int. Cl. G06F 17/00; G06K 7/10; G06Q 30/00; G06Q 40/00; G06Q 20/00; G06Q 50/00

(52) U.S. Cl. 235/377; 235/375; 705/13; 705/34; 705/41

(57) ABSTRACT

The present disclosure relates to a system and method for using a mobile device for vending payments. The system is provided with one or more processors configured to receive input and create a vending account; communicate vending transaction details with the mobile device; charge the vending account based upon the vending transaction details; communicate a code authorizing the vending transaction to the mobile device; and transfer funds to a vendor related to the vending transaction.

### CROSS-REFERENCE TO RELATED APPLICATIONS

Not Applicable

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

When parking in a parking space associated with a typical parking meter, a customer might deposit coins into the meter to pay a fee for the use of the parking space. In an advance over the traditional parking meter, a customer might be able to prepay a certain amount of parking expenses. In an example of this case, the customer might have a card or similar device in or on which a magnetic strip, a radio frequency identification transmitter, or a similar information retention mechanism is embedded. The information retention mechanism on the card might maintain a record of the balance of the customer's prepay parking account. When the customer places the card on or near an appropriately equipped parking meter, a parking fee can be added to the meter and a corresponding amount can be deducted from the customer's account.

Alternatively, instead of a parking meter, some other type of identifier for the parking space might be present. For example, a freestanding sign with an identification number for the parking space might be located in a position where a traditional parking meter would typically be located, a placard or other identifying sign might be placed on the ground or on a wall near the parking space, or other ways of identifying the parking space well known to one of skill in the art may be used instead of a traditional parking meter. The customer might enter the identifying information for the parking space into a portable electronic device, such as a cell phone, and the device might cause a parking fee to be deducted from the customer's prepay account. Any such meter or identifier for a parking space will be referred to herein as a parking meter but it should be understood that an apparatus that would traditionally be considered a parking meter might not be present at the parking space.

Prepay systems such as these or other prepay parking systems well known to those of skill in the art can provide an advantage over traditional coin-based systems in that the customer does not need to carry or obtain coins. However, such systems can also have several drawbacks. For example, a prepay system can be inconvenient because the customer may need to remember to add funds to the prepay balance periodically. The procedure for adding funds may be burdensome or time-consuming. Also, the customer may need to remember to carry the prepay card or other prepay device. In addition, the customer may not be able to easily determine the balance on the prepay account. In some cases, the account balance may expire if not used within a certain period of time. Also, the income a municipality or other entity receives from parking fees might be reduced by the expenses incurred in maintaining a prepay system. Also, some individual may not be aware of or have access to prepay systems, so the parking meters would still need to be able to accept coins or other forms of payment.

### SUMMARY

In one embodiment, a system is provided to promote using a mobile device for vending payments, comprising one or more processors configured to receive input and create a vending account; communicate vending transaction details with the mobile device; charge the vending account based upon the vending transaction details; communicate a code authorizing the vending transaction to the mobile device; and transfer funds to a vendor related to the vending transaction.

In another embodiment, a method is provided for parking, comprising creating an account at a parking web server; receiving, by the parking web server from a mobile device, information regarding a parking space; charging a fee to park in the parking space to the account; and transmitting confirmation that parking space payment arrangements have been made.

In another embodiment, a device for wireless telecommunications, comprising a display; a processor; and a graphical user interface having a parking aspect displayable on the display such that responsive to selecting the parking aspect. The processor is programmed to identify a parking space, receive information regarding parking in the parking space, and responsive to selecting to pay a fee to park in the parking space, promoting charging the fee to an account associated with the device.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 illustrates a parking fee payment system according to an embodiment of the disclosure.

FIGS. 2a-2d illustrate parking fee payment interfaces according to an embodiment of the disclosure.

FIGS. 3a and 3b illustrates a parking fee payment enforcement system according to an embodiment of the disclosure.

FIG. 4 illustrates a method for paying a parking fee according to an embodiment of the disclosure.

FIG. 5 illustrates a method for paying a parking fee according to an embodiment of the disclosure.

FIG. 6 is a diagram of a wireless communications system including a mobile device operable for some of the various embodiments of the disclosure.

FIG. 7 is a block diagram of a mobile device operable for some of the various embodiments of the disclosure.

FIG. 8 is a diagram of a software environment that may be implemented on a mobile device operable for some of the various embodiments of the disclosure.

FIG. 9 is a diagram of a system that is operable for some of the various embodiments of the disclosure.

### DETAILED DESCRIPTION

It should be understood at the outset that although an illustrative implementation of one embodiment of the disclosure is illustrated below, the system may be implemented using any number of techniques, whether currently known or in existence. The disclosure should in no way be limited to the illustrative implementations, drawings, and techniques illustrated below, including the exemplary design and implementation illustrated and described herein, but may be modified within the scope of the appended claims along with their full scope of equivalents.

In an embodiment, a system is provided whereby a mobile telecommunications-capable device can be used to pay for parking. A customer may access a parking web server via the internet for example, using a mobile device or a personnel computer, and establish an account with the parking web server. Any easily portable device that is capable of connecting to a wireless telecommunications network, such as a cell or other mobile phone, a personal digital assistant, a portable computer, or a similar device, will be referred to herein as a mobile device. When a customer parks a vehicle in a parking space associated with a parking meter equipped as described herein, a mobile device may transmit an identifier for the parking meter to the parking web server. The identifier may be entered manually by the customer or wirelessly transmitted to the wireless device from the parking meter. The parking web server may communicate with an entity that manages the parking meter and cause the parking meter to be electronically credited with the appropriate fee for parking in the parking space. The fee may be applied to the parking meter by the entity that manages the parking meter directly for example by an internet connection. The fee may also be applied indirectly by sending a code to the mobile device, which may transmit the code to the parking meter.

The meter management entity might then communicate with the parking meter and/or with the mobile device to cause an indication that the fee has been credited to appear on the parking meter and/or on the mobile device. The meter management entity might also update its records to indicate that the fee has been credited so that those records can be used to enforce the payment of parking fees. The parking web server can place the parking fees on the customer's bill, which may be mailed or directly billed to a credit card or other payment method stored on the parking webserver. In this way, the need for a customer to prepay parking fees is eliminated and the disadvantages previously mentioned for prepay systems can be avoided.

The parking web server may provide a graphical user interface (GUI) for customers to enter account information. Account information may comprise customer data such as the customer's mailing address, billing address, phone numbers, email addresses, credit card information and billing preferences. The parking web server may be accessed via the internet through a hand held device or personal computer or some other means of remotely accessing a server. A customer may access the parking web server GUI at substantially any time to modify or add customer data stored on the parking web server. The parking web server may use the customer data on behalf of the customer for parking related fees.

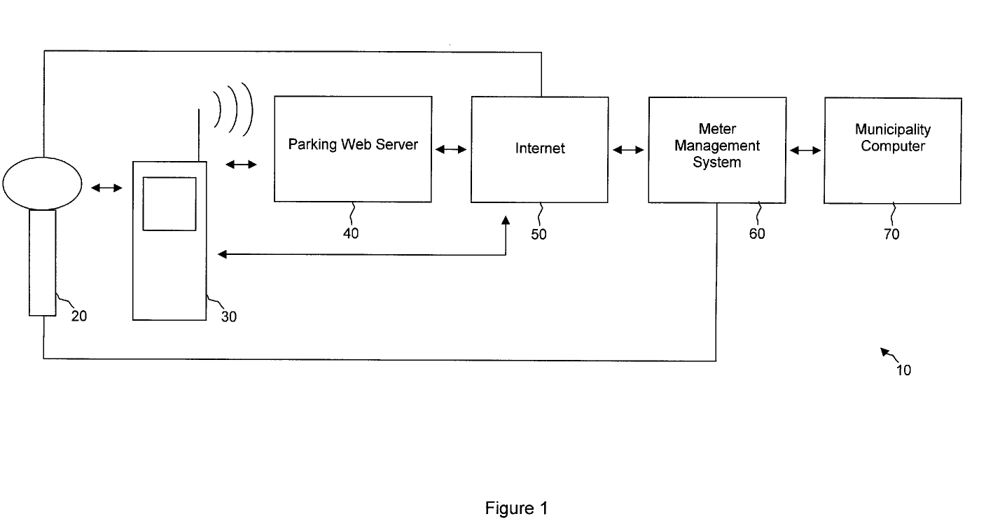

FIG. 1 illustrates an embodiment of a system 10 that can allow the payment of parking fees via a mobile device 30. When a customer parks a vehicle in a parking space associated with a parking meter 20, identifying information for the parking meter 20 can be manually entered into the customer's mobile device 30 or transmitted from the parking meter 20 to the mobile device 30 via wireless technology, for example bluetooth. As mentioned previously, the parking meter 20 might be a traditional parking meter that displays identifying information or that has been given additional functionality related to the current payment system, might be a sign or other apparatus containing identifying information associated with the parking space, or might be some other type of pay station that associates identifying information with a parking space.

The association of the parking meter 20 with the mobile device 30 can be accomplished in several different manners. In one embodiment, the parking meter 20 might display a serial number or similar identifying text. The customer could enter this identifier into the mobile device 30 by manually keying the number into the keypad on the mobile device 30, by speaking the number into a voice recognition system in the mobile device 30, or by other well known data entry techniques.

In another case, the mobile device 30 might be equipped with a global positioning system (GPS) or similar system for determining the location of the mobile device 30. The mobile device 30 might transmit information regarding its location to a parking web server 40 and the parking web server 40 might transmit this information to a parking meter management system 60, described in detail below. The meter management system 60 might be able to use this information to determine the nearest parking meter 20 to the location of the mobile device 30 and to automatically enter an identifier for that parking meter 20 into the mobile device 30. Alternatively, the identifier or other information to associate the mobile device 30 with that particular parking space might simply be recorded by the meter management system 60.

In another case, the parking meter 20 might be equipped with a radio frequency identification (RFID) transmitter or a similar proximity-based identity transmission system. The mobile device 30 might be equipped with an RFID receiver or some other receiver appropriate for the type of transmitter on the parking meter 20. The customer might bring the mobile device 30 into the proximity of the parking meter 20 and the identity transmission system on the parking meter 20 might cause an identifier for the parking meter 20 to be transmitted to the mobile device 30. In a variation of this embodiment, the mobile device 30 might be equipped with the transmitter and the parking meter 20 might be equipped with the receiver. Bringing the mobile device 30 into the proximity of the parking meter 20 might cause identifying information for the mobile device 30 to be sent to the parking meter 20.

In yet another case, the parking meter 20 and the mobile device 30 might be equipped with a Bluetooth data transmission system or other wireless data transmission system. When the customer brings the mobile device 30 into the proximity of the parking meter 20, the wireless data transmission system might cause an identifier for the parking meter 20 to be transmitted to the mobile device 30 or an identifier for the mobile device 30 to be transmitted to the parking meter 20 or both. One of skill in the art will recognize other ways in which an identifier for the parking meter 20 may be entered into the mobile device 30.

Regardless of how the identifier is received by the mobile device 30, the identifier can be transmitted by the mobile device 30 to the parking web server 40 or to the meter management system 60 or both.

In the cases where identifying information for the mobile device 30 is transmitted to the parking meter 20, the parking meter 20 might transmit its identifier and the identifying information for the mobile device 30 to the parking web server 40, to the parking meter management system 60, or to the Internet 50, or other intermediate networks, and thence to the parking meter management system 60 or parking web server 40.

In one case, the identifier for the parking meter 20 may be entered into the mobile device 30 before contacting the parking web server 40. In this case, the mobile device 30 might have a menu item that, when selected, causes a user interface to appear on the mobile device 30 into which the identifier can be entered. The identifier may be entered manually by the user or transmitted wirelessly from the parking meter 20 to the wireless device 30. Upon entry of the identifier and other parking-related information into the user interface, the mobile device 30 may then communicate with the parking web server 40 and provide the identifier and the other parking-related information to the parking web server 40. The user might manually make the connection, such as by dialing a telephone number or browsing to the parking web server 40 website, or the mobile device 30 might automatically make the connection responsive to the user entering the identifier and the other parking-related information into the user interface.

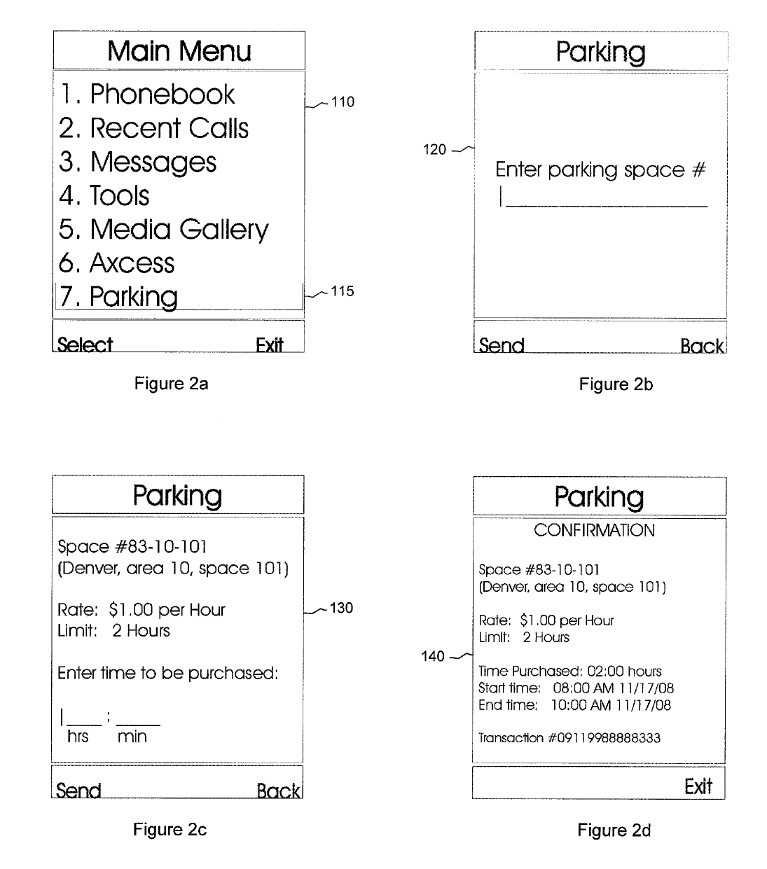

FIGS. 2a-2d illustrate user interfaces that might appear on the display screen of the mobile device 30 in an example of this embodiment. In FIG. 2a, a main menu user interface 110 lists a plurality of menu items, one of which is a parking menu item 115. When the parking menu item 115 is selected, a second user interface 120 shown in FIG. 2b might appear, into which the identifier for a selected parking space can be entered. When the identifier has been entered, a third user interface 130 shown in FIG. 2c might appear, wherein information about the parking space might be displayed and into which a desired period of parking time can be entered. When the desired parking time has been entered, a connection may be made to the parking web server 40 or the mobile device 30 might otherwise communicate the information that has been entered to the parking web server 40. In response a fourth user interface 140, shown in FIG. 2d, may appear, wherein a confirmation of the purchase of parking time for the selected parking space is displayed. The confirmation might include a transaction number for the parking event that might be used for recording purposes by the meter management system 60 and for confirmation purposes by the customer.

In another case, the mobile device 30 might connect to the parking web server 40 before the identifier for the parking meter 20 is entered into the mobile device 30. In this case, a connection to the parking web server 40 might be made, for example, using a web browser of the mobile device 30. Upon connection, the parking web server 40 might cause one or more user interfaces, such as those shown in FIGS. 2a-2d, to appear on the mobile device 30 into which the identifier and other parking-related information can be entered. Each time parking-related information is entered into the user interfaces, the information could be sent to the parking web server 40 and the parking web server 40 might then send another user interface into which further information could be entered.

FIGS. 2b-2d might again be used to illustrate this embodiment. When the mobile device 30 connects to the parking web server 40, the parking web server 40 might transmit or otherwise cause the user interface 120 of FIG. 2b to be displayed on the mobile device 30. A parking space identifier may be entered by the customer or wirelessly provided by the parking meter 20 as described above and sent to the parking web server 40. The parking web server 40 might then transmit the user interface 130 of FIG. 2c to the mobile device 30 and the customer might enter a period of parking time as described above and send the time to the parking web server 40. The parking web server 40 might then send a confirmation as described above and as depicted in FIG. 2d.

In either of these cases, the identifying information for the parking meter 20 and the other parking-related information might be transmitted from the mobile device 30 to the parking web server 40 or the meter management system 60 in the form of a Short Message Service (SMS) text message or in some other common data transmission protocol, such as TCP/IP.

Upon receiving the identifier for the parking meter 20, the parking web server 40 can cause a credit for the fee for parking at the parking meter 20 to be recorded at the parking meter 20 and/or at the meter management system 60. Various arrangements for the transfer of funds for the parking fee will be discussed in detail below. In an embodiment, communication between the parking web server 40 and the meter management system 60 occurs via the Internet 50, but other connections could be used.

In one case, the customer can use the mobile device 30 to specify the amount of the fee that should be credited to the parking meter 20. For example, as shown in FIG. 2c, the customer might enter a desired length of parking time into the keypad of the mobile device 30. The mobile device 30 might then send that desired length of time to the parking web server 40. A fee appropriate for that length of time might then be electronically credited to the parking meter 20 and/or the meter management system 60 and displayed on the mobile device 30. The fee may be credited to the parking meter 20 by the meter management system 60 directly contacting the parking meter 20. The fee may also be credited to the parking meter 20 by receiving confirmation at the mobile device 30 and then forwarding the confirmation from the mobile device 30 to the parking meter 20, in this case, the parking meter 20 may only be capable of communication with the mobile device 30.

In another case, a timer in the parking meter 20 or in the meter management system 60 might start counting at the time the identifier for the parking meter 20 is transmitted to the parking web server 40. When the customer moves the vehicle from the parking space, the customer might connect to the parking web server 40 to inform the parking web server 40 that the parking space is being vacated and the timer might stop counting. A fee based on the length of time the vehicle was in the parking space might be calculated and billed at that point.

When the customer uses the mobile device 30 to pay for parking and upon completion of payment arrangements, an indication may appear on the parking meter 20 to provide the customer and parking fee enforcement officials with confirmation that payment arrangements have been made. For example, if the customer uses the keypad on the mobile device 30 to specify that one dollar should be credited to the parking meter 20, an amount of one dollar might appear on a display on the parking meter 20. Alternatively an amount of time might be purchased and the time, instead of the dollar amount, might appear on the display of the parking meter 20. The amount shown on the display might decrease with the passage of time in the manner of the displays on some traditional parking meters. In the case where the parking fee is calculated after the parking space is vacated, the parking meter 20 might display some other type of indication that the vehicle is legally parked.

In another case, the parking meter 20 may display an indicator if it has transmitted its identifier to the mobile device 30. The indicator may be displayed as soon as the identifier is transmitted, in this case the parking meter 30 does not wait for a confirmation from the parking web server 40 or meter management system 60. The parking meter may be manufactured without a radio receiver to reduce cost or size. The parking web server 40 or meter management system 60 may transmit a SMS message to the mobile device 30 to notify the customer that payment has been successful with or without notifying the parking meter 20.

In some cases, the customer may prepay via the mobile device 30 or at the parking web server 40 for time and receive a credit if the customer vacates the parking space early and notifies the provider or system, such as via the mobile device 30. Further the system may notify the user, via the mobile device 30, when the meter expires or is about to expire and allow the user to pay for additional parking time.

In a case when the customer uses the mobile device 30 to pay for parking, the meter management system 60 might update its records to indicate that a fee for the parking space has been paid. These records might be used by the parking web server 40 to determine the amount for parking fees that should be added to the customer's bill. The parking web server 40 might update the customer's account each time a fee is incurred or might periodically consult the records of the meter management system 60 to add the fees to the bill on a batch basis. These records might be also used, in a manner described in detail below, in parking fee enforcement efforts.

One of skill in the art will recognize that the above steps do not necessarily need to occur in the order stated. For example, the updating of the display on the parking meter 20, the updating of the records in the meter management system 60, and the addition of a parking fee to a customer's bill could take place substantially simultaneously or in various sequences.

The meter management system 60 might include one or more computers that are capable of connecting to the Internet 50 and, through the Internet 50, to the parking meter 20. The computers might also be capable of connecting to the parking meter 20 through the parking web server 40, through a direct connection, or through some other type of connection. The meter management system 60 might also include a database or a similar data storage system in which parking records obtained from the parking meter 20 and from the mobile device 30 can be stored and from which the records can be retrieved. Appropriate software for managing the parking meter 20, the database, and the fees related to the parking meter 20 might also be present in the meter management system 60.

In another case, the meter management system 60 can be accessed or used by another entity for parking enforcement purposes. For example, the meter management system 60 might manage the parking spaces, lots, and so on for numerous entities. These other entities would typically be a city, a county, or some other municipality that receives the fees from the parking meter 20. The other entity might also be an airport; an academic institution; an operations or management entity that controls a large parking lot or garage such as the parking lot or garage for a stadium, an arena, or a theater; or a similar entity. The term ‘municipality’ will be used herein to refer to any entity that can access the records of or employ all or portions of the meter management system 60 and use the records and systems to enforce and collect the payment of parking fees.

The municipality might have a computer 70 that can access the records of the meter management system 60. The municipality computer 70 might have the capability to use the records to display a graphical depiction of the parking meters 20 for which a fee has currently been paid and the parking meters 20 for which a fee has not currently been paid. The display might include a map of the streets, garages, or other locations at which the parking meters 20 are present. A user of the municipality computer 70 might be able to zoom in on the streets in the map and view an indicator associated with each parking meter 20 in the municipality. The indicators might show whether or not each parking meter 20 is currently credited with a parking fee. This information could then be used for parking fee enforcement purposes.

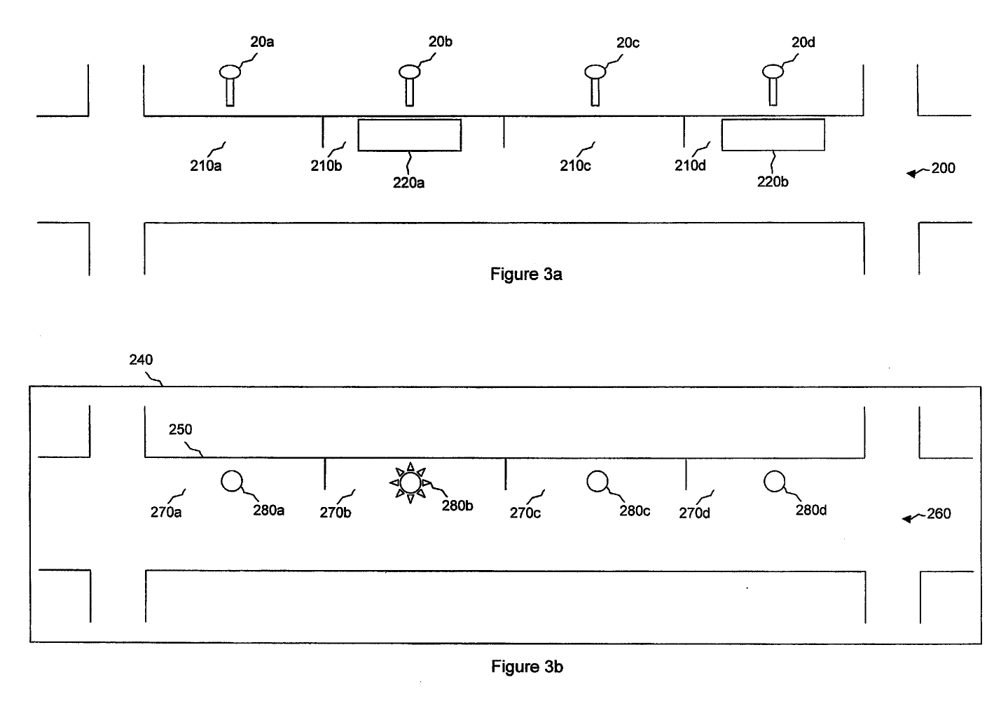

FIGS. 3a and 3b illustrate such a scenario. In FIG. 3a, a plurality of parking meters 20 are present on a street 200. Each parking meter 20 is associated with a parking space 210. That is, a first parking meter 20a is associated with a first parking space 210a, a second parking meter 20b is associated with a second parking space 210b, and so on. In this example, a first vehicle 220a is parked in the second parking space 210b and a second vehicle 220b is parked in the fourth parking space 210d. It will be assumed for this example that a fee has currently been paid for the second parking meter 20b but that a fee has not currently been paid for the fourth parking meter 20d. That is, the second vehicle 220b is in violation of the parking regulations for the municipality in which the street 200 is located.

FIG. 3b illustrates a display screen 240 that might appear on the municipality computer 70. The screen 240 includes a map 250 that depicts the street 200 and the parking spaces 210 illustrated in FIG. 3a. That is, a virtual street 260 corresponds to the actual street 200 and a plurality of virtual parking spaces 270 correspond to the actual parking spaces 210. An indicator 280 is associated with each of the virtual parking spaces 270 to provide a graphical depiction of whether a fee has currently been paid for the parking meter 20 associated with the actual parking space 210 depicted by the virtual parking space 270. That is, when a fee is paid for one of the parking meters 20, the corresponding indicator 280 will provide an indication that the fee has been paid. The indicators 280 might be lights that are illuminated when a fee has been paid and that are not illuminated when a fee has not been paid, lights that are a first color when a fee has been paid and a second color when a fee has not been paid, pairs of lights, one of which is a first color when a fee has been paid and the other of which is a second color when a fee has not been paid, or other types of indicators well known to those of skill in the art.

A user of the municipality computer 70, such as an enforcement officer using a laptop computer or other handheld or portable device, can observe the indicators 280 on the screen 240 and determine which parking meters 20 on the street 200 are currently credited with a parking fee. In this example, it can be seen that indicator 280b is illuminated and the other indicators 280 are not illuminated. This indicates that a fee has currently been paid for the second parking space 210b but that a fee has not currently been paid for the other parking spaces 210a, 210c, and 210d.

An observation can then be made of the actual parking spaces 210. It will be seen that the second parking space 210b and the fourth parking space 210d are occupied and that the first parking space 210a and the third parking space 210c are unoccupied. When a comparison is made between the parking spaces 210 for which a fee has been paid and the parking spaces 210 that are occupied, it will be observed that the second vehicle 220b is occupying the fourth parking space 210d without having paid a sufficient fee.

In another case, the municipality computer 70 may not be aware that a parking meter has been paid, for example, a parking meter may be paid with coins at the parking meter. In this case, the parking meter might not be capable of communication with the meter management system 60. However, the parking meters may be capable of short range wireless communication, for example Bluetooth, infrared or other short range wireless communications. As the user of the municipality computer 70 approaches a parking meter that is capable of such short range communications and, for example, that has been paid with coins, the parking meter may automatically wirelessly connect to the municipality computer 70 which may in turn relay the payment information so as to update the records of the meter management system 60 to indicate the amount of time paid for at the parking meter. In this manner, parking meters that are not able to directly communicate with the meter management system 60 are able to indirectly communicate via the municipality computer 70 periodically.

In one case, the municipality computer 70 is a personal digital assistant, a portable computer, or a similar device that can be carried by a parking enforcement officer. The officer might walk alongside the street 200 with the municipality computer 70 and compare occupied parking spaces 210 with the indicators 280 on the municipality computer 70. Alternatively, the officer might ride in a vehicle along the street 200 and compare occupied parking spaces 210 with the indicators 280 on the municipality computer 70. In these cases, the municipality computer 70 might be equipped with a printer that allows a citation to be printed on the spot when a violation is observed. In one embodiment, the municipality computer 70 might be equipped with a positioning system, such as a geographical positioning system (GPS), so that the enforcement officer or the enforcement officer's vehicle carrying the municipality computer 70 may be identifiable on the street 200 or elsewhere. This might be useful to allow the enforcement officer to more readily determine the location of nearby parking spaces and thereby simplify enforcement.

In another case, the municipality computer 70 might remain in a fixed location and cameras might be used to monitor the parking spaces 210. A first parking enforcement officer at the fixed location could make a comparison between the indicators 280 and presence of vehicles in the parking spaces 210 as observed on a monitor. When such a comparison reveals a parking violation, the first parking enforcement officer could dispatch a second parking enforcement officer to the location of the violation.

In yet another case, the municipality computer 70 could be coupled to a system that automatically detects the presence of vehicles in the parking spaces 210, perhaps through the use of sonar or other well known vehicle detection techniques. When the municipality computer 70 and the vehicle detection system together detect the presence of a vehicle in a parking space 210 for which a fee has not been paid, enforcement actions could be initiated against the vehicle. One of skill in the art will recognize other ways in which the indicators 280 on the display screen 240 of the municipality computer 70 could assist in enforcing the payment of parking fees.

As mentioned previously, the transfer of funds for a parking fee between the customer, the parking web server 40, the meter management system 60, and the municipality can be carried out in several different ways. In one embodiment, when the parking web server 40 receives the customer's payment for a bill in which parking fees are included, the parking web server 40 might keep a percentage of the parking fee portion of the payment as a service fee. The parking web server 40 might then send the remaining parking fee portion of the payment to the entity that manages the meter management system 60. The entity that manages the meter management system 60 might keep a percentage of this remaining portion as a service fee and send the remainder of the parking fee portion of the payment to the municipality.

In another case, at or shortly after the time the customer uses the mobile device 30 to credit a parking fee to the parking meter 20, the parking web server 40 might send the amount of the parking fee to the municipality. The parking web server 40 might later send the customer a bill that includes a service fee in addition to the parking fee sent to the municipality. When the customer pays the bill, the parking web server 40 might keep a portion of the service fee and send the remainder of the service fee to the entity that manages the meter management system 60.

In yet another case, at or shortly after the time the customer uses the mobile device 30 to credit a parking fee to the parking meter 20, the parking web server 40 might send the amount of the parking fee and a first service fee to the entity that manages the meter management system 60. The entity that manages the meter management system 60 might then send the amount of the parking fee to the municipality and keep the first service fee for itself. The parking web server 40 might later send the customer a bill that includes a second service fee in addition to the parking fee and the first service fee. When the customer pays the bill, the parking web server 40 might keep the first and second service fees and the parking fee for itself.

In still other cases, the entity that manages the meter management system 60 might initiate and manage the fee payment process and might be reimbursed by the parking web server 40 when the parking web server 40 receives payment from the customer. One of skill in the art will recognize various combinations of the above and/or other arrangements that could be made for the payment of parking fees to the municipality and the payment of service fees to the parking web server 40 and to the entity that manages the meter management system 60.

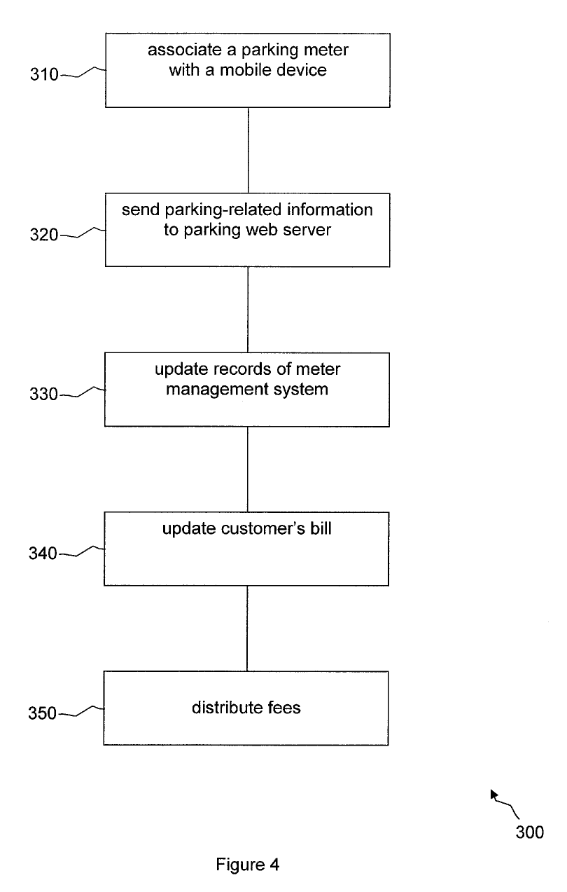

FIG. 4 illustrates a method 300 for using a mobile device to pay a parking fee. In block 310, a parking meter is associated with a mobile device. The association might be made by the mobile device user entering an identification number for the parking meter into the mobile device or through other techniques. In block 320, parking-related information is sent to a parking web server. The parking web server might then send the information to a parking meter management system. In other embodiments, the parking-related information might be sent directly to the parking meter management system. In block 330, the records of the meter management system are updated to indicate that a parking fee has been credited to the parking meter. The records might be used to assist in the enforcement of parking fees. The parking meter might also be updated to indicate that the parking fee has been credited. In block 340, the parking web server updates the customer's bill with the parking fee. In block 350, the parking fee and any service fees charged by the parking web server and by the meter management system are distributed among the parking web server, the meter management system, and the municipality that controls the parking meter.

In some cases, the parking web server might receive some benefit, such as a fee or charge for each parking event, or for enabling user access to the parking system, or other financial benefit. When the user pays their bill for the parking fees, the parking web server might then disperse all or portions of the collected fees to the meter management system entity and municipality or other parking space entity.

It should be understood that the above steps do not necessarily need to occur in the stated sequence. For example, the updating of the meter management system's records, the updating of the bill, and the distribution of fees could occur in other orders. One of skill in the art will recognize other sequences in which the steps in the method 300 could occur.

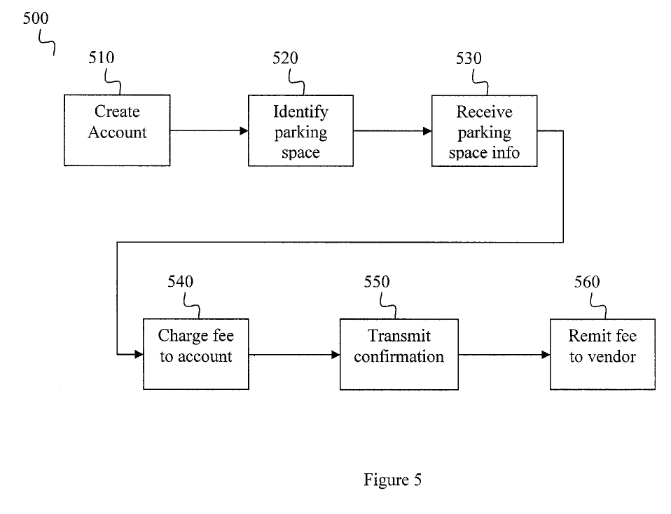

Turning now to FIG. 5, a method for web based payment of fees 500 is illustrated. At step 510, a user may log onto a parking web server and create an account. The user may log on through a web interface on a mobile device or some other device capable of remotely accessing the parking web server. The account may contain data about the user, for example, the user's address, contact numbers, credit card numbers, or other information required to complete a transaction with a vendor. The following description relates to the user paying for a parking space. One skilled in the art will realize that this method may be used in other vending situations where a vendor requires a payment, for example, vending machines, toll booths, and gasoline pumps, or others.

At step 520, the user approaches a desired parking space and identifies the parking space to the mobile device. The identification may be accomplished by the user manually entering some sort of identifier displayed on the parking space or on an associated parking meter. The identification may also be accomplished by the parking meter associated with the parking space containing a wireless transmitter, for example, Bluetooth or Wi-Fi, which transmits an identifier of the parking space to the mobile device. After identifying the parking space, the user may enter a desired amount of time or desired fee to pay for the parking space into the mobile device.

At step 530, the mobile device then provides the identifier along with the desired amount of time or desired fee to the parking web server. In some cases, the parking web server may handle the entire procedure, but in some cases the parking web server might interface with a meter management system. The meter management system may comprise information about parking spaces, for example availability and fees associated with the parking space. In some embodiments, the parking web server may maintain or otherwise have access to the necessary parking information without communicating with the meter management system.

At step 540, the parking web server may charge the account of the user for the fee associated with the parking space. For example, the account may contain the user's credit card information, or some other form of electronic payment method that the parking web server may bill for the fee associated with the parking space. Instead of a credit card payment, the user may choose to establish a prepay account at the parking web server before using the parking space, in this case, the parking web server may deduct the amount of the parking fees from the user's prepaid account balance. Other payment arrangements are described herein and still others will readily suggest themselves to one skilled in the art, any of which might be used or various arrangements might be used in combination.

At step 550, the parking web server may then transmit confirmation of the payment of fees to the parking meter associated with the parking space. The parking web server may communicate directly with the parking meter or via the management system or otherwise, for example, the parking web server may transmit confirmation to the mobile device which in turn may transmit confirmation to the parking meter. Responsive to receiving confirmation, the parking meter may display the amount of the fee applied to the meter or the amount of time purchased. The confirmation may take the form of a code or other message, such as an encrypted, coded, hashed or other message that verifies to the parking meter that the communication from the mobile device is authentic and/or legitimately authorized.

At step 560, the parking web server may transmit or otherwise arrange for payment of all or a portion of the fees collected to the vendor of the parking space, such as the associated municipality. The transmission of fees to the vendor may happen substantially simultaneously with the purchase, or may happen on a periodic basis, for example weekly or monthly.

A parking payment system as described herein can provide enhancements to customers and municipalities. For the customer, a service might be provided whereby the customer is allowed access to a portion of the records of the meter management system. The customer might then be able to use a mobile device to search the records to find a convenient parking space. For example, if the mobile device is equipped with a GPS system, the customer's GPS-based location information could be combined with the records of the meter management system. This combined information could then be used to create a map that could be displayed on the screen of the mobile device and could show the presence of vacant parking spaces near the customer's current location.

The records of the meter management system could also be used to automatically send an alert to the customer's mobile device when the purchased time on a parking meter is about to expire. The alert might offer the customer the opportunity to extend the time on the parking meter. Upon receiving the alert, the customer might choose to vacate the parking space before the time expires, might return to the parking space to add money to the parking meter either manually or via the mobile device, or might use the mobile device to remotely credit the parking meter with additional funds.

Other services that may be available to the customer when a system such as that described herein is in place include access to premium parking spaces that would not be available to non-users of this system and the opportunity to pay parking citations via the mobile device. One of skill in the art might recognize other services that might be made available to customers who make use of this system.

Also, the use of a mobile device as described herein to pay parking fees can eliminate many of the drawbacks to the customer of a prepay parking plan. The customer does not need to remember to periodically add funds to the prepay balance. The burden and time required for adding funds are eliminated. The customer does not need to remember to carry a prepay card or other prepay device since payment is made via a mobile device that the customer might already be carrying for other purposes. The customer does not need to determine the remaining balance on a prepay account and there is no prepay account balance that could expire.

Parking web servers that offer services such as these to their customers might be able to enhance their revenues through the collection of service fees for managing the payment of parking fees. Municipalities that adopt a parking payment system such as this can reduce the expenses incurred in maintaining prepay systems and/or traditional parking fee payment systems. For example, it is well known in the art that a high percentage of the revenue generated through parking fees is lost through theft and vandalism. It is also well known that a large portion of the revenue collected from parking fees is spent on maintenance of equipment and manual collection of money from parking meters. The use of a parking payment system as described herein can reduce some or all of these losses and expenses and thus increase the net revenue a municipality receives from parking fees. In addition, a municipality might enter into a contract with the entity that manages the meter management system to perform some of the parking fee-related functions that were previously performed by the municipality. This might further reduce the direct expenses that are incurred by the municipality.

While the present system may be used in conjunction with coin operated parking meters, coin operated meters are not necessary for the present system. In fact, a municipality employing the present system may entirely eliminate their coin operated meters. Coin operated meters have a number of drawbacks including the cost of collecting the coins, vandalism, and the actual cost of the coin operated meters. By employing the present system and eliminating coin operated meters, the municipality would enjoy considerable savings.

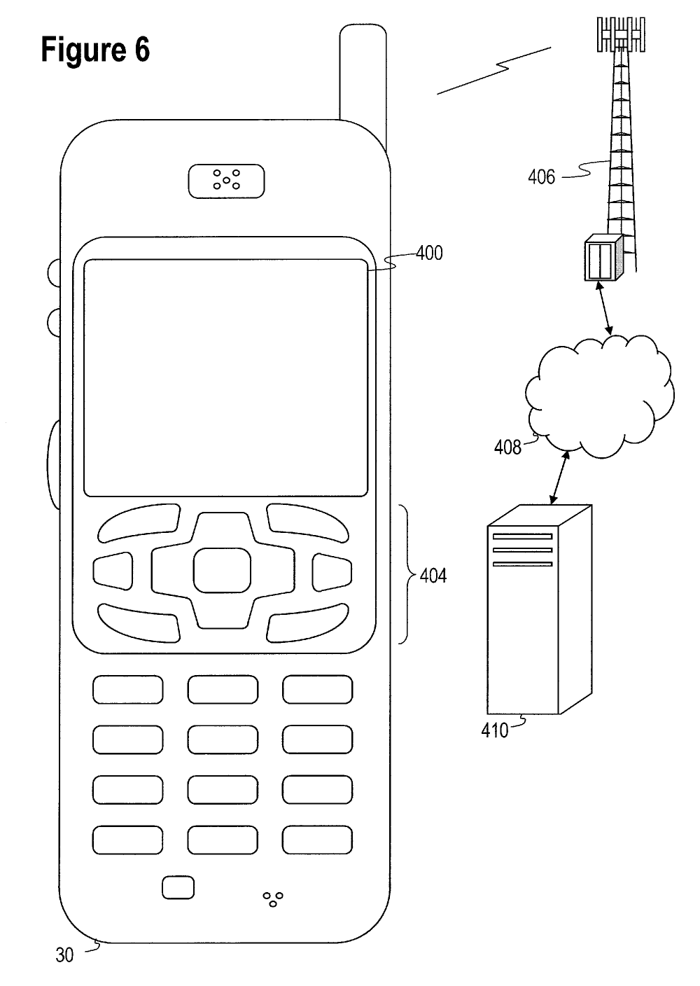

FIG. 6 shows a wireless communications system including the mobile device 30. The mobile device 30 is operable for implementing aspects of the disclosure, but the disclosure should not be limited to these implementations. Though illustrated as a mobile phone, the mobile device 30 may take various forms including a wireless handset, a pager, a personal digital assistant (PDA), a portable computer, a tablet computer, or a laptop computer. Many suitable mobile devices combine some or all of these functions. In some embodiments of the disclosure, the mobile device 30 is not a general purpose computing device like a portable, laptop or tablet computer, but rather is a special-purpose communications device such as a mobile phone, wireless handset, pager, or PDA.

The mobile device 30 includes a display 400 that might include the screen 240. The mobile device 30 also includes a touch-sensitive surface or keys 404 for input by a user. The mobile device 30 may present options for the user to select, controls for the user to actuate, and/or cursors or other indicators for the user to direct. The mobile device 30 may further accept data entry from the user, including numbers to dial or various parameter values for configuring the operation of the mobile device 30. The mobile device 30 may further execute one or more software or firmware applications in response to user commands. These applications may configure the mobile device 30 to perform various customized functions in response to user interaction.

Among the various applications executable by the mobile device 30 are a web browser, which enables the display 400 to show a web page. The web page is obtained via wireless communications with a cell tower 406, a wireless network access node, or any other wireless communication network or system. The cell tower 406 (or wireless network access node) is coupled to a wired network 408, such as the Internet. Via the wireless link and the wired network, the mobile device 30 has access to information on various servers, such as a server 410. The server 410 may provide content that may be shown on the display 400.

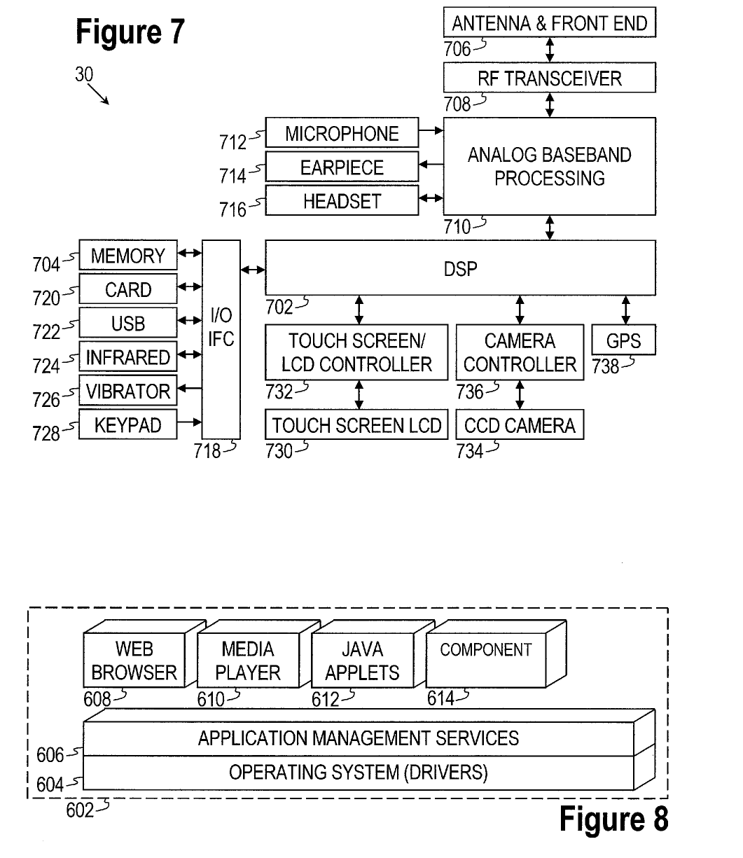

FIG. 7 shows a block diagram of the mobile device 30. The mobile device 30 includes a digital signal processor (DSP) 702 and a memory 704. As shown, the mobile device 30 may further include an antenna and front end unit 706, a radio frequency (RF) transceiver 708, an analog baseband processing unit 710, a microphone 712, an earpiece speaker 714, a headset port 716, an input/output interface 718, a removable memory card 720, a universal serial bus (USB) port 722, an infrared port 724, a vibrator 726, a keypad 728, a touch screen liquid crystal display (LCD) with a touch sensitive surface 730, a touch screen/LCD controller 732, a charge-coupled device (CCD) camera 734, a camera controller 736, and a global positioning system (GPS) sensor 738.

The DSP 702 or some other form of controller or central processing unit operates to control the various components of the mobile device 30 in accordance with embedded software or firmware stored in memory 704. In addition to the embedded software or firmware, the DSP 702 may execute other applications stored in the memory 704 or made available via information carrier media such as portable data storage media like the removable memory card 720 or via wired or wireless network communications. The application software may comprise a compiled set of machine-readable instructions that configure the DSP 702 to provide the desired functionality, or the application software may be high-level software instructions to be processed by an interpreter or compiler to indirectly configure the DSP 702.

The antenna and front end unit 706 may be provided to convert between wireless signals and electrical signals, enabling the mobile device 30 to send and receive information from a cellular network or some other available wireless communications network. The RF transceiver 708 provides frequency shifting, converting received RF signals to baseband and converting baseband transmit signals to RF. The analog baseband processing unit 710 may provide channel equalization and signal demodulation to extract information from received signals, may modulate information to create transmit signals, and may provide analog filtering for audio signals. To that end, the analog baseband processing unit 710 may have ports for connecting to the built-in microphone 712 and the earpiece speaker 714 that enable the mobile device 30 to be used as a cell phone. The analog baseband processing unit 710 may further include a port for connecting to a headset or other hands-free microphone and speaker configuration.

The DSP 702 may send and receive digital communications with a wireless network via the analog baseband processing unit 710. In some embodiments, these digital communications may provide Internet connectivity, enabling a user to gain access to content on the Internet and to send and receive e-mail or text messages. The input/output interface 718 interconnects the DSP 702 and various memories and interfaces. The memory 704 and the removable memory card 720 may provide software and data to configure the operation of the DSP 702. Among the interfaces may be the USB interface 722 and the infrared port 724. The USB interface 722 may enable the mobile device 30 to function as a peripheral device to exchange information with a personal computer or other computer system. The infrared port 724 and other optional ports such as a Bluetooth interface or an IEEE 802.11 compliant wireless interface may enable the mobile device 30 to communicate wirelessly with other nearby mobile devices and/or wireless base stations.

The input/output interface 718 may further connect the DSP 702 to the vibrator 726 that, when triggered, causes the mobile device 30 to vibrate. The vibrator 726 may serve as a mechanism for silently alerting the user to any of various events such as an incoming call, a new text message, and an appointment reminder.

The keypad 728 couples to the DSP 702 via the interface 718 to provide one mechanism for the user to make selections, enter information, and otherwise provide input to the mobile device 30. Another input mechanism may be the touch screen LCD 730, which may also display text and/or graphics to the user. The touch screen LCD controller 732 couples the DSP 702 to the touch screen LCD 730.

The CCD camera 734 enables the mobile device 30 to take digital pictures. The DSP 702 communicates with the CCD camera 734 via the camera controller 736. The GPS sensor 738 is coupled to the DSP 702 to decode global positioning system signals, thereby enabling the mobile device 30 to determine its position. Various other peripherals may also be included to provide additional functions, e.g., radio and television reception.

FIG. 8 illustrates a software environment 602 that may be implemented by the DSP 702. The DSP 702 executes operating system drivers 604 that provide a platform from which the rest of the software operates. The operating system drivers 604 provide drivers for the mobile device hardware with standardized interfaces that are accessible to application software. The operating system drivers 604 include application management services (“AMS”) 606 that transfer control between applications running on the mobile device 30. Also shown in FIG. 8 are a web browser application 608, a media player application 610, and Java applets 612. The web browser application 608 configures the mobile device 30 to operate as a web browser, allowing a user to enter information into forms and select links to retrieve and view web pages. The media player application 610 configures the mobile device 30 to retrieve and play audio or audiovisual media. The Java applets 612 configure the mobile device 30 to provide games, utilities, and other functionality. A component 614 might provide functionality related to the payment of parking fees.

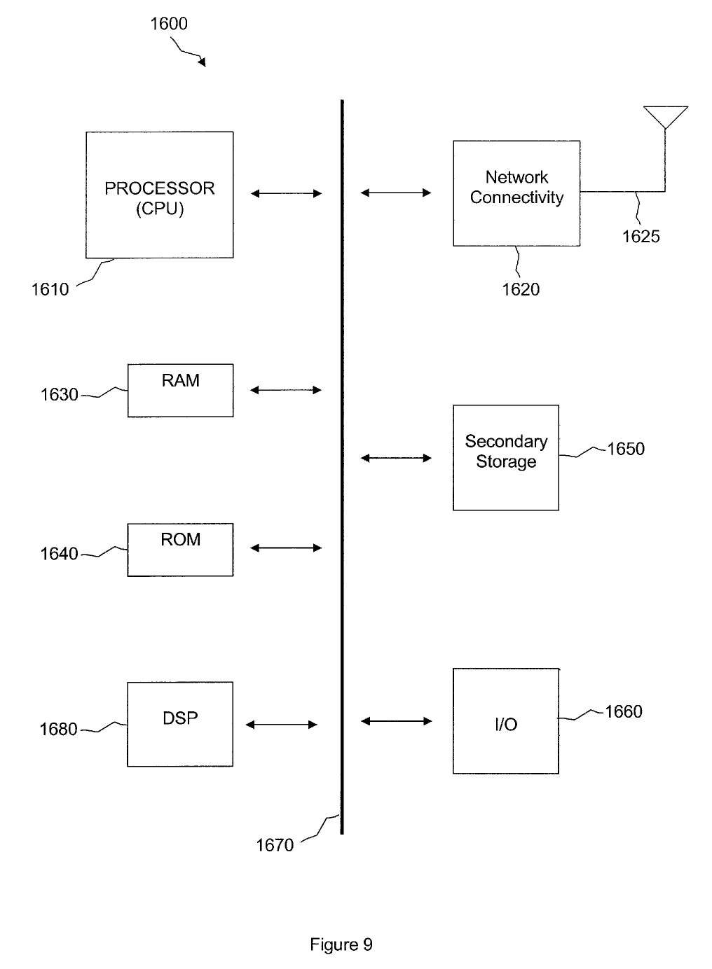

The parking web server described above might include a system that is capable of the actions described above. FIG. 9 illustrates an example of a system 1600 that includes a processing component 1610 suitable for implementing one or more embodiments disclosed herein. In addition to the processor 1610 (which may be referred to as a central processor unit or CPU), the system 1600 might include network connectivity devices 1620, random access memory (RAM) 1630, read only memory (ROM) 1640, secondary storage 1650, and input/output (I/O) devices 1660. These components might communicate with one another via a bus 1670. In some cases, some of these components may not be present or may be combined in various combinations with one another or with other components not shown. These components might be located in a single physical entity or in more than one physical entity. Any actions described herein as being taken by the processor 1610 might be taken by the processor 1610 alone or by the processor 1610 in conjunction with one or more components shown or not shown in the drawing, such as a digital signal processor (DSP) 1680. Although the DSP 1680 is shown as a separate component, the DSP 1680 might be incorporated into the processor 1610.

The processor 1610 executes instructions, codes, computer programs, or scripts that it might access from the network connectivity devices 1620, RAM 1630, ROM 1640, or secondary storage 1650 (which might include various disk-based systems such as hard disk, floppy disk, or optical disk). While only one CPU 1610 is shown, multiple processors may be present. Thus, while instructions may be discussed as being executed by a processor, the instructions may be executed simultaneously, serially, or otherwise by one or multiple processors. The processor 1610 may be implemented as one or more CPU chips.

The network connectivity devices 1620 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1620 may enable the processor 1610 to communicate with the Internet or one or more telecommunications networks or other networks from which the processor 1610 might receive information or to which the processor 1610 might output information. The network connectivity devices 1620 might also include one or more transceiver components 1625 capable of transmitting and/or receiving data wirelessly.

The RAM 1630 might be used to store volatile data and perhaps to store instructions that are executed by the processor 1610. The ROM 1640 is a non-volatile memory device that typically has a smaller memory capacity than the memory capacity of the secondary storage 1650. ROM 1640 might be used to store instructions and perhaps data that are read during execution of the instructions. Access to both RAM 1630 and ROM 1640 is typically faster than to secondary storage 1650. The secondary storage 1650 is typically comprised of one or more disk drives or tape drives and might be used for non-volatile storage of data or as an over-flow data storage device if RAM 1630 is not large enough to hold all working data. Secondary storage 1650 may be used to store programs that are loaded into RAM 1630 when such programs are selected for execution.

The I/O devices 1660 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1625 might be considered to be a component of the I/O devices 1660 instead of or in addition to being a component of the network connectivity devices 1620.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed:

1. A system to promote using a mobile device for vending payments, comprising:
one or more processors configured to:
receive input and create a vending account;
communicate vending transaction details with a mobile device;
charge the vending account based upon the vending transaction details; and
communicate a code authorizing the vending transaction to the mobile device.

2. The system of claim 1, wherein the vending account is further defined as a parking account and the vending transaction is further defined as a parking transaction.

3. The system of claim 2, wherein the transaction details include information identifying a parking space and an amount of time to purchase.

4. The system of claim 1 wherein the code is further defined as a secure code.

5. The system of claim 1 wherein the code is provided to the mobile device from the system.

6. The system of claim 2 further comprising:
communicating parking transaction details with a meter management system; and
arranging for the transfer of funds to a vendor related to the vending transaction

7. The system of claim 1 wherein the vending account is a prepay account.

8. The system of claim 1 wherein a credit card associated with the vending account is charged for the vending transaction.

9. A method for parking, comprising:
creating an account at a parking web server;
receiving, by the parking web server from a mobile device, information regarding a parking space;
charging a fee to park in the parking space to the account; and
transmitting confirmation that parking space payment arrangements have been made.

10. The method of claim 9, further comprising:
notifying via the mobile device, regarding a parking time expiration; and
selecting to pay an additional fee to park in the parking space.

11. The method of claim 9, further comprising:
notifying responsive to vacating the parking space; and
receiving a refund responsive to vacating the space before an expiration of time paid for by the fee.

12. The method of claim 9, further comprising remitting at least a portion of the charged fees to an associated municipality.

13. The method of claim 9 further comprising associating one of a prepaid account and a credit card with the account.

14. The method of claim 9, wherein the confirmation is transmitted first to the mobile device and then from the mobile device to a parking meter.

15. A device for wireless telecommunications, comprising:
a display;
a processor; and
a graphical user interface having a parking aspect displayable on the display, wherein the processor is programmed to:
promote communication with a parking web server regarding a parking account;
receive information regarding parking in a parking space;
provide the parking space information to the parking web server;
receive an authorization from the parking web server related to parking in the parking space; and
provide the authorization to the parking meter associated with the parking space.

16. The device of claim 15, wherein the graphical user interface displays the fee associated with parking in the parking space.

17. The device of claim 15, wherein the parking identifier is wirelessly received from the parking space.

18. The device of claim 15, wherein the parking identifier is wirelessly received from the parking space via Bluetooth connection.

19. The device of claim 15, wherein the processor is further configured to receive a confirmation.

20. The device of claim 19 wherein the processor is further configured to transmit the confirmation to a parking meter.
